(19) United States
(12) Patent Application Publication
(10) Pub. No.: US 2008/0152421 A1
(43) Pub. Date: Jun. 26, 2008

(54) Adjustable page binder system

(76) Inventor: Kurt Sward, Deerfield, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/644,142

(22) Filed: Dec. 22, 2006

(51) Int. Cl. B42F 13/12

(52) U.S. Cl. 402/70

(57) ABSTRACT

An adjustable page binder system is provided. The system has a plurality of flexible substrates having a first surface, a second surface, and an edge. The substrates also have a plurality of pairs of first and second apertures, and a slit joining the first and second aperture of each pair. The system further has a binder with a front cover, a back cover, and a plurality of ring connectors. The ring connectors have a generally elliptical cross-sectional geometry with a major axis of the elliptical cross-sectional geometry extending generally parallel to a binding of the binder. Further, the ring connectors further have a leading edge and a trailing edge. The ring connectors are sized to fit within the first aperture of each pair of apertures in the flexible substrates. The leading edge of each ring connector is designed to separate the slit to allow the ring connector to be transitioned to the appropriate second aperture.

### TECHNICAL FIELD

The present invention relates generally to a system for adjusting pages from a first position to a second position, and more specifically to a combination of a binder and page system wherein the pages can be adjusted up and down.

### BACKGROUND OF THE INVENTION

Binders and insert pages are well known in the art. Standard binders typically provide for retaining the insert pages in a single vertical position. While such binders and insert pages according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally relates to an adjustable page binder system. The page binder system generally comprises a binder having a plurality of ring connectors and a plurality of pages therein having a plurality of pairs of joined first and second apertures.

According to one embodiment, the pages of flexible substrates have a first surface, a second surface, and an edge. The substrates also have a plurality of pairs of first and second apertures, and a slit joining the first and second apertures of each pair, respectively.

According to another embodiment, the adjustable page binder system further comprises a binder having a front cover, a back cover, and a plurality of ring connectors therebetween. The plurality of ring connectors has a generally elliptical cross-sectional geometry with a major axis extending generally parallel to a binding of the binder. The ring connectors also have a leading edge and a trailing edge. The ring connectors are sized to fit within the first aperture of each pair of apertures in the flexible substrates, and the leading edges of the ring connectors are designed to separate the slit. This allows the ring connectors to be transitioned to the appropriate second aperture, and then back to the appropriate first aperture.

According to another embodiment, the adjustable page binder system may further comprise a first pair of shoulders at the connection between the first apertures and the slit, and a second pair of shoulders at the connection between the second apertures and the slit. The shoulders are provided to prevent opening of the slit until an appropriate amount of force is applied to the shoulder by one of the edges of the ring connector. The ring connectors may have a wedge at the leading edge, such that when an appropriate amount of force is applied the wedge will transition the slit from the normally closed state to the open state. After the ring connector is removed from the slit the shoulder and slit will transition again to the normally closed state.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of an adjustable page binder system with the pages in the first position;

FIG. 2 is a perspective view of the adjustable page binder system of FIG. 1 with one of the pages in the second position;

FIG. 3A is a view of one embodiment of a ring connector for the adjustable page binder system;

FIG. 3B is a cross-sectional view of the ring connector of FIG. 3A; and

FIGS. 4A-E are partial cross-sectional views of a ring connector transitioning from a first aperture (i.e., first position) to a second aperture (i.e., second position).

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

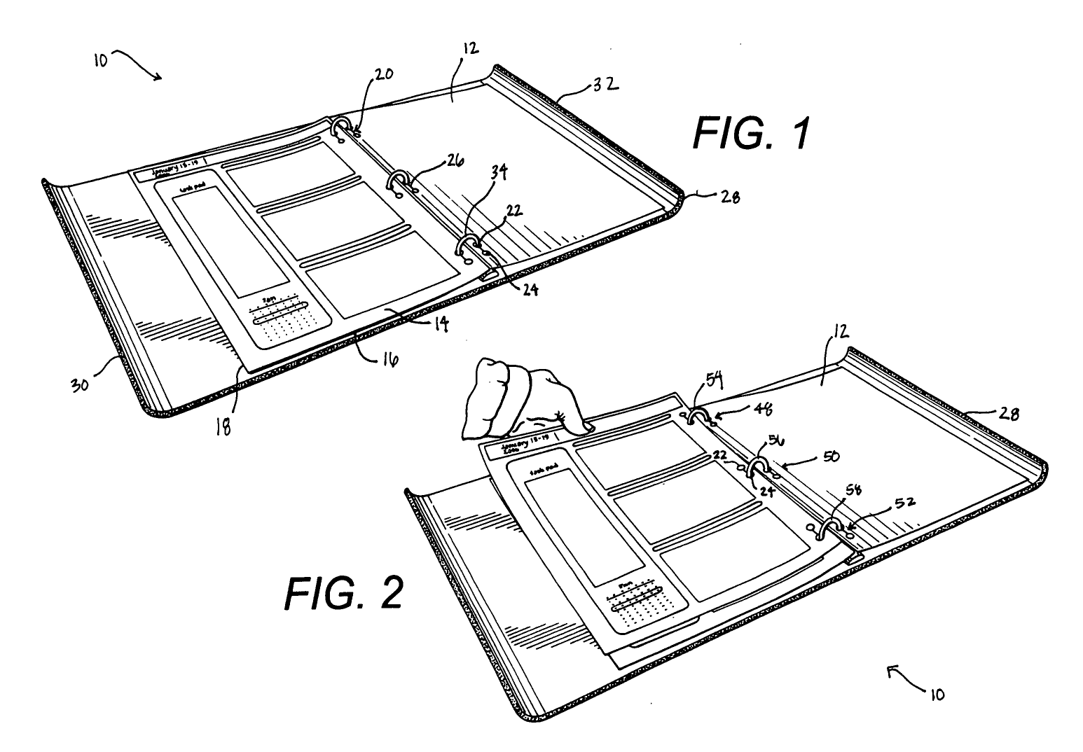

Referring now to the figures, and specifically to FIGS. 1 and 2, there is shown an adjustable page binder system 10. The page binder system 10 comprises a plurality of flexible substrates 12 and a binder 28. Each substrate 12 has a first surface 14, a second surface 16, and an edge 18. Each substrate 12 also has a plurality of pairs 20 of first and second apertures 22, 24. In one embodiment, the pairs of apertures 20 are aligned vertically along the length of the substrate 12. Preferably, the pairs of apertures 20 may be equally spaced apart from one another along the length of the substrate 12.

In one embodiment, a slit 26 joins the first and second apertures 22, 24 of each pair of apertures 20. In a preferred embodiment, the slit 26 has substantially zero-width. While the slit 26 is preferably of zero-width, other widths may also be used. For example, the slit 26 could be a channel which a ring connector 34 can pass through.

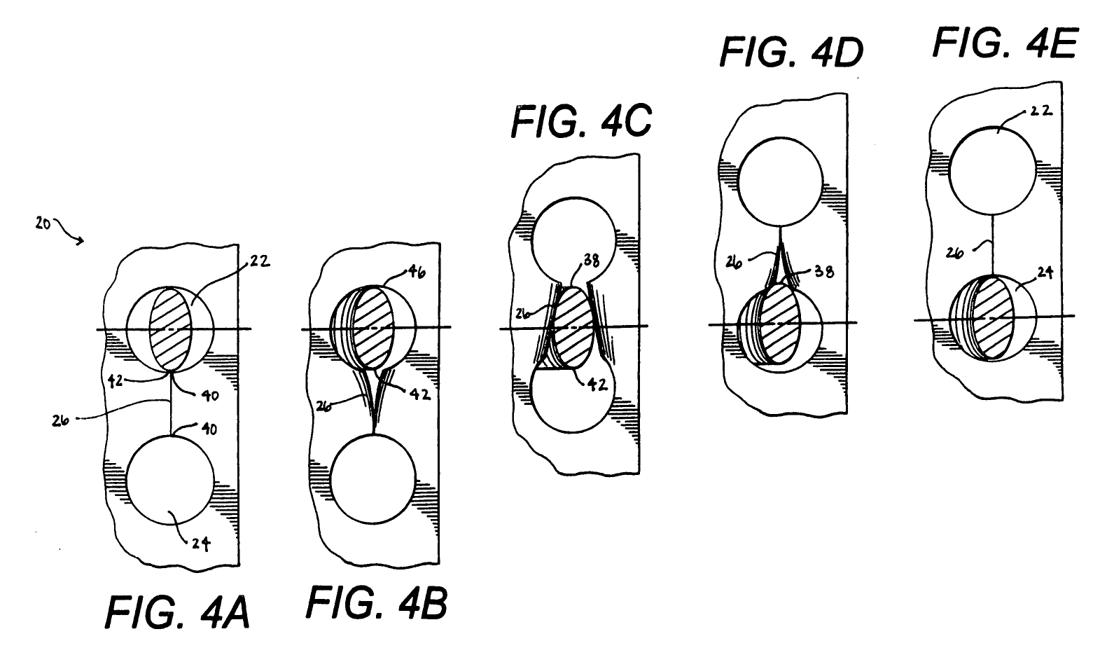

Referring to FIGS. 4A-4E, in one embodiment a first pair of shoulders 40 is located between the first apertures 22 and the slit 26. A second pair of shoulders 40 is located at the connection between the second apertures 24 and the slit 26. The shoulders 40 are provided to prevent the opening of the slit 26 until an appropriate amount of force is applied to the shoulder 40 by the edges 36, 38 of the ring connector 34. The force that opens the slit 26 results from the interaction between the ring connector 34 and the slit 26, at the shoulder 40 thereof, such that the substrate 12 can be jogged.

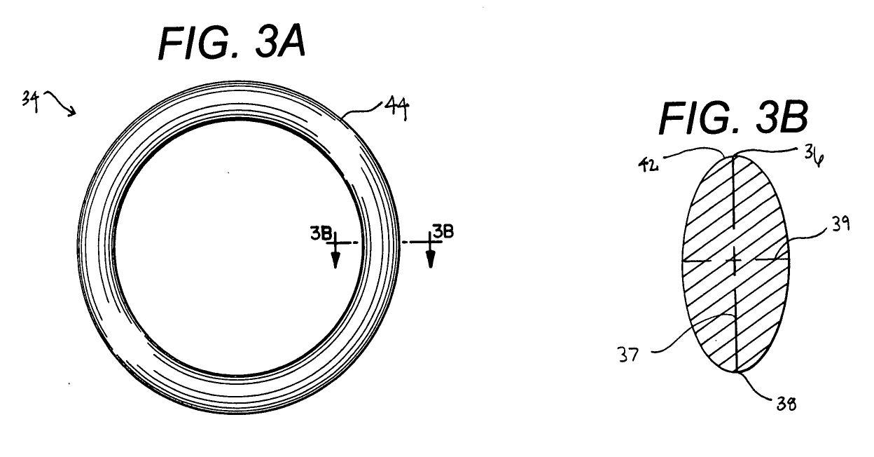

The adjustable page binder system 10 further comprises a binder 28 having a front cover 30, a back cover 32 and a plurality of ring connectors 34. In one embodiment, the ring connectors 34 are located between the front and back covers 30, 32 of the binder 28, and they are aligned with each other along the length of the binder 28. As shown in FIGS. 3A and 3B, in a preferred embodiment, each ring connector 34 has a generally elliptical cross-sectional geometry. Further, the generally elliptical cross-sectional geometry of the ring connector 34 has a major axis 37 that extends generally parallel to a binding 35 of the binder 28, along the length of the binder 28.

As shown in the figures, the ring connectors 34 also have a leading edge 36 and a trailing edge 38. The ring connectors 34 are sized to fit within the first and second apertures 22, 24 in the flexible substrate 12 and to allow the pages to be hinged on the ring connectors 34. The ring connectors 34, however, have a minor diameter 39 that is larger than the slit 26 thickness (which in one embodiment is approximately zero). The leading edge 36 and trailing edge 38 of each ring connector 34 is designed to open the shoulders 40 and separate the slit 26, as identified herein.

The geometry of the ring connectors 34 allows the ring connector 34 to separate the slit 26 and to assist in transitioning the ring connectors 34 from the first aperture 22 to the second aperture 24 within each pair of apertures 20. Once this occurs, the page 12 is “jogged” out of place such that a user can easily find the particular page 12. Thus, to mark a page 12, the user must simply jog the page 12, such that it is retained by the ring connectors 34 in the second apertures 24 respectively, as opposed to identifying the page 12 with a tab, or a post-it note, or folding the page 12. Accordingly, a user can easily set apart and later identify a particular page 12, even if the user does not have anything to mark the page 12 with. Once the user no longer wishes to have a particular page 12 marked, the user need simply jog the page 12 back to its original aligned position in the first set of apertures 22. To jog the page 12 back to its original or first position, the trailing edge 38 of the ring connectors 34 is pushed against the shoulder 40 to open the slit 26 to allow the ring connectors 34 to pass through the slit 26 again in transitioning the ring connectors 34 from the second aperture 24 to the first aperture 22. After the ring connector 34 passes through the slit 26, the shoulder 40 will revert to its original position and the slit 26 will close to prevent any undesired opening of the slit 26. Not only is this method of marking a page 12 simple for the user, it ensures that the substrate 12 will not be damaged from having a tab stuck on and peeled off, or from having been folded.

The ring connectors 34, as shown in FIG. 3B, may also include a wedge-shaped configuration 42 at the leading edge 36. The wedge-shaped configuration 42 may assist in opening the shoulder 40 to have the ring connector 34 pass through the slit 26. The force that opens the slit 26 results from the interaction between the ring connector 34 and the slit 26 at the shoulder 40 thereof, such that the substrate 12 can be jogged.

Thus, the shoulder 40 acts to secure the ring connector 34 in a particular aperture 22, 24 until an appropriate amount of force is applied to move the shoulder 40 and open the slit 26. For example, as shown in FIG. 4A, when an insufficient amount of force is applied, whether intentionally or inadvertently, the shoulder 40 will abut the wedge-shaped configuration 42 of the leading edge 36 of the ring connector 34, and the shoulder 40 will prevent the ring connector 34 from opening the slit 26. However, once enough force is applied to overcome the shoulder 40, as shown in FIG. 4B, the wedge-shaped configuration 42 will open the slit 26.

Referring to FIGS. 4B-4D, after the wedge 42 has applied enough pressure to move the shoulder 40 and open the slit 26, the ring connector 34 may smoothly transition the slit 26 from the normally closed state to the open state as the ring connector 34 passes through the slit 26 from the first aperture 22 to the second 24. After the slit 26 has opened, and the ring connector 34 has transitioned from a first aperture 22 to a second aperture 24, the shoulder 40 at the first aperture 22 closes (see FIG. 4B) and then after the ring connector 34 is fully within the second aperture 24, the shoulder 40 of the second aperture 24 will also close, allowing the slit 26 to close behind the trailing edge 38 of the ring connector 34. The elliptical shape of the cross-section and the smoothness of the wedge-shaped configuration 42 of the ring connector 34 ensures that the slit 26 will smoothly open instead of tearing, and further that the slit 26 will close again after the transition has occurred.

As shown in FIG. 3, the ring connectors 34 have a generally circumferential perimeter 44. However, the perimeter 44 may be in other suitable geometries, such as “D” shaped. In a preferred embodiment, the cross-section of the ring connectors 34 is consistent about the perimeter, such that each point on the ring connector 34 has a leading edge 36 and a trailing edge 38. Thus, the flexible substrates 12 can be “jogged” from the first aperture 22 to the second aperture 24 from any location around the ring connector 34. Moreover, the substrate 12 does not need to be lifted or moved to a certain location along the ring connector 34 before the substrate 12 is jogged. This makes it much easier for the user to jog a substrate 12. Thus, the uniform cross-section of the ring connector 34 about the perimeter 44 creates a move convenient method of jogging.

As shown in FIGS. 4A-4E, in one embodiment the apertures 22, 24 have a diameter 46 corresponding in size to the length of the major axis of the cross-section of the ring connectors 34. This allows the ring connectors 34 to easily be received by both the first and second apertures 22, 24.

In a preferred embodiment, as shown in FIGS. 1 and 2, the adjustable page binder system 10 includes substrates 12 that have a first, second, and third series 48, 50, 52 of first and second apertures 22, 24, such that there are three pairs 48, 50, 52 of apertures. The system 10 includes a first, second, and third ring connector 54, 56, 58, which are received, respectively, in the first, second, and third series 48, 50, 52 of apertures. The first second and third ring connectors 54, 56, 58 pass through the corresponding sets of apertures 48, 50, 52, respectively.

Initially, the first, second, and third ring connectors 54, 56, 58 are all aligned so that they pass through the first aperture 22 in the first second and third series 48, 50, 52, of each of the substrates 12. Thus, all of the substrates 12 are initially aligned. As shown in the series of figures, FIGS. 4A-E, once a certain amount of force is applied, between the ring connector 34 and the appropriate shoulders 40, a substrate 12 will transition such that the first, second, and third ring connectors 54, 56, 58 will be pass from the first aperture 22, through the slits 26 of the substrates 12, and into the second apertures 24. After the ring connectors 54, 56, 58 have transitioned to the second aperture 24 of the first, second, and third series 48, 50, 52 of apertures, the particular substrate 12 will be jogged, making it easily identifiable.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and the claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. An adjustable page binder system, comprising:
a plurality of flexible substrates having a first surface, a second surface and an edge, the substrates having plurality of pairs of first and second apertures, and a slit joining the first and second apertures of each pair, respectively; and,
a binder having a front cover, a back cover, and a plurality of ring connectors therebetween, the plurality of ring connectors having a generally elliptical cross-sectional geometry with a major axis of the generally elliptical cross-sectional geometry extending generally parallel to an axis defined by the ring connectors, the ring connectors further having a leading edge and a trailing edge, wherein the ring connectors are sized to fit within the first aperture of each pair of apertures in the flexible substrates, respectively, and wherein the leading edge of the ring connectors are designed to separate the slit to allow the ring connectors to be transitioned to the appropriate second aperture.

2. The adjustable page binder system of claim 1, further comprising a first pair of shoulders at the connection between the first apertures and the slit, and a second pair of shoulders at the connection between the second apertures and the slit, the shoulders provided to prevent opening of the slit until an appropriate amount of force is applied to the shoulder by one of the edges of the ring connector.

3. The adjustable page binder system of claim 1, wherein the leading edge of the ring connectors is wedge-shaped to transition the slit from a normally closed state to an open state.

4. The adjustable page binder system of claim 1, wherein the ring connectors have a generally circumferential perimeter.

5. The adjustable page binder system of claim 4, wherein the cross-sectional geometry of the ring connectors is consistent about the perimeter.

6. The adjustable page binder system of claim 1, wherein the apertures have a diameter corresponding in size to the length of the major axis of the cross-section of the ring connectors.

7. The adjustable page binder system of claim 1, wherein the substrates have a first, a second, and a third series of first and second apertures.

8. The adjustable page binder system of claim 7, wherein a first, second, and third ring connector pass through the first, second, and third series of apertures, respectively.

9. The adjustable page binder system of claim 8, wherein initially, the first, second, and third ring connectors are all aligned with the first aperture of the first, second, and third series of apertures, respectively.

10. The adjustable page binder system of claim 9, wherein once a certain amount of force is applied, the substrate will transition such that the first, second, and third ring connectors will all be aligned with the second aperture of the first, second, and third series of apertures.

11. An adjustable page binder system, comprising:
a binder having a front cover, a back cover, and a plurality of ring connectors therebetween, the plurality of ring connectors having a generally elliptical cross-sectional geometry with a major axis of the generally elliptical cross-sectional geometry extending generally parallel to an axis defined by the ring connectors, the ring connectors further having a leading edge and a trailing edge;
a plurality of flexible substrates having a first surface and a second surface, the substrates having plurality of pairs of apertures, each pair of apertures having a first aperture and a second aperture extending through the substrate from the first surface to the second surface thereof, and each pair of apertures having an openable and reclosable slit of substantially zero width joining the first and second apertures; and,
a first pair of shoulders at the connection between the first apertures and the slit, and a second pair of shoulders at the connection between the second apertures and the slit, the shoulders provided to prevent opening of the slit until an appropriate amount of force is applied to the shoulder by one of the edges of the ring connector.

12. The adjustable page binder system of claim 11, wherein the leading edge of the ring connectors is wedge-shaped, such that when an appropriate amount of force is applied, the wedge will displace the shoulder and transition the slit from a normally closed state to an open state, and wherein the slit returns to the normally closed state after the ring connectors are positioned in the aperture.

13. The adjustable page binder system of claim 11, wherein the ring connectors have a generally circumferential perimeter.

14. The adjustable page binder system of claim 13, wherein the cross-sectional geometry of the ring connectors is consistent about the perimeter.

15. The adjustable page binder system of claim 11, wherein the apertures have a diameter corresponding in size to the length of the major axis of the cross-section of the ring connectors.

16. The adjustable page binder system of claim 11, wherein the substrates have a first, second, and third series of first and second apertures.

17. The adjustable page binder system of claim 16, wherein initially, a first, second, and third ring connector pass through the first aperture of the first, second, and third series of apertures, respectively.

18. The adjustable page binder system of claim 17, wherein once a certain amount of force is applied, the substrate will transition such that the first, second, and third ring connectors will all be aligned with the second aperture of the first, second, and third series of apertures.

19. An adjustable page binder system, comprising:
a binder having a front cover, a back cover, and a plurality of ring connectors therebetween, the plurality of ring connectors have a generally elliptical cross-sectional geometry with a major axis of the generally elliptical cross-sectional geometry extending generally parallel to an axis defined by the ring connectors, the ring connectors further having a wedge-shaped leading edge and a trailing edge;
a plurality of flexible substrates having a first surface, a second surface and an edge, the substrates having plurality of pairs of apertures, each pair of apertures having a first aperture and a second aperture extending through the substrate from the first surface to the second surface thereof, and each pair of apertures having an openable and reclosable slit of substantially zero width joining the first and second apertures, the slit adapted to transition from a normally closed state to an open state, and back to the normally closed state; and,
a first pair of shoulders at the connection between the first apertures and the slit, and a second pair of shoulders at the connection between the second apertures and the slit, the shoulders provided to prevent opening of the slit until an appropriate amount of force is applied to the shoulder by one of the edges of the ring connector.

20. The adjustable page binder system of claim 19, wherein the cross-section of the ring connectors is consistent about the perimeter.
